(19) United States
(12) Patent Application Publication
(10) Pub. No.: US 2007/0090794 A1
(43) Pub. Date: Apr. 26, 2007

(54) Wall outlet device having emergency light

(75) Inventors: Chih Ming Chen, Taichung (TW); Chih Shen Chen, Taichung (TW)

Correspondence Address: CHARLES E. BAXLEY, ESQ., 90 JOHN STREET, THIRD FLOOR, NEW YORK, NY, 10038, US

(73) Assignee: Jason EL Technology Co., Ltd.

(21) Appl. No.: 11/250,841

(22) Filed: Oct. 14, 2005

(51) Int. Cl. H02J 7/00

(52) U.S. Cl. 320/114

(57) ABSTRACT

A wall outlet device includes a light device received in a housing and having one or more light members coupled to one or more chargeable batteries, and a control device having a sensing/switching device for electrically coupling to a power supply, and electrically coupled to the light members of the light device, for detecting whether the power supply is supplied to the sensing/switching device of the control device or not, and for controlling the chargeable battery to energize the light member of the light device and to light the dark environment when the power supply is not supplied to the sensing/switching device of the control device, such as when on fire.

### BACKGROUND OF THE INVENTION

1. Field of the Invention

The present invention relates to a wall outlet device, and more particularly to a wall outlet device having an emergency light device for generating indicating light when the electric power source is cut off, particularly for the dark environment.

2. Description of the Prior Art

Typical wall outlet devices or electric power outlet devices or the like comprise one or more socket openings formed therein for receiving or plugging various kinds of plugs or the like, and/or one or more switches provided therein for controlling various kinds of electric facilities.

For example, U.S. Pat. No. 5,708,554 to Liner discloses one of the typical power outlet boxes having a special protection logic, and having a master outlet and one or more secondary outlets provided therein for plugging purposes.

However, the typical power outlet boxes or the typical wall outlet devices do not have any emergency light devices for generating indicating light when the electric power source is cut off. For example, for the dark environment, particularly in the smoky and dark fire buildings, the typical power outlet boxes or the typical wall outlet devices may not be used to generate any indicating light when the electric power source is cut off.

U.S. Pat. No. 5,746,492 to Tai discloses one of the typical emergency light devices for generating indicating light when the electric power source is cut off or when on fire. However, the users have to purchase the typical emergency light devices and to plug or to couple the typical emergency light devices to the electric power source. The typical power outlet boxes or the typical wall outlet devices do not have any emergency light devices for generating indicating light when the electric power source is cut off.

The present invention has arisen to mitigate and/or obviate the afore-described disadvantages of the conventional wall or electric outlet devices.

### SUMMARY OF THE INVENTION

The primary objective of the present invention is to provide a wall outlet device having emergency light including an emergency light device for generating indicating light when the electric power source is cut off, particularly for the dark environment.

In accordance with one aspect of the invention, there is provided a wall outlet device comprising a housing including a chamber formed therein, a light device received in the chamber of the housing, and including at least one light member for generating a light out of the housing, at least one chargeable battery coupled to the light member of the light device, for selectively energizing the light device, and a control device including a sensing/switching device for electrically coupling to a power supply, and electrically coupled to the light member of the light device, for detecting whether the power supply is supplied to the sensing/switching device of the control device or not, and for controlling the chargeable battery to energize the light member of the light device when the power supply is not supplied to the sensing/switching device of the control device, and in order to form or to act as an emergency light device and energize the light members of the light device to light the dark environment, particularly when on fire.

The housing includes at least one aperture formed in a front portion thereof, and the light member of the light device is engaged in the aperture of the housing. The housing includes a cover attached to a front portion thereof for shielding and protecting the light member of the light device.

The light device includes a switch attached to a circuit board for controlling the light member, and the cover includes a pathway formed therein and aligned with the switch, for allowing the switch to be actuated and operated by a user. The light device includes a pair of conductor members attached to the circuit board and engaged with the chargeable battery, for attaching the chargeable battery to the electric board.

The housing includes a casing attached to a rear portion thereof and having a chamber formed therein for receiving the control device therein. The casing includes at least one passage formed therein, and at least one pair of conductor blades engaged in the chamber of the casing and aligned with the passage of the casing, for allowing one or more electric wires to engage into the chamber of the casing and to be electrically coupled to the pair of conductor blades.

The casing includes at least one projection extended therefrom, and the housing includes at least one ear extended therefrom and having a lock hole formed therein for receiving the projection of the casing, and for coupling the casing to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front perspective view of a wall outlet device having emergency light in accordance with the present invention;

FIG. 2 is a rear perspective view of the wall outlet device having emergency light;

FIG. 3 is another front perspective view similar to FIG. 1, in which a portion of the wall outlet device has been cut off for showing an inner structure of the wall outlet device;

FIG. 4 is a cross sectional view of the wall outlet device, taken along lines 4-4 of FIG. 5;

FIG. 5 is a cross sectional view of the wall outlet device, taken along lines 5-5 of FIG. 4;

FIG. 6 is an exploded view of the wall outlet device having emergency light;

FIG. 7 is a partial perspective view illustrating an outer housing of the wall outlet device, in which a portion of the outer housing has been cut off for showing an inner structure of the outer housing;

FIG. 8 is a partial perspective view illustrating a cover of the wall outlet device, in which a portion of the cover has been cut off for showing an inner structure of the cover;

FIG. 9 is a perspective view illustrating the operation of the wall outlet device; and

FIGS. 10 and 11 are perspective views similar to FIG. 9, illustrating the other application of the wall outlet device.

### DETAILED DESCRIPTION OF THE PREFERRED EMBODIMENT

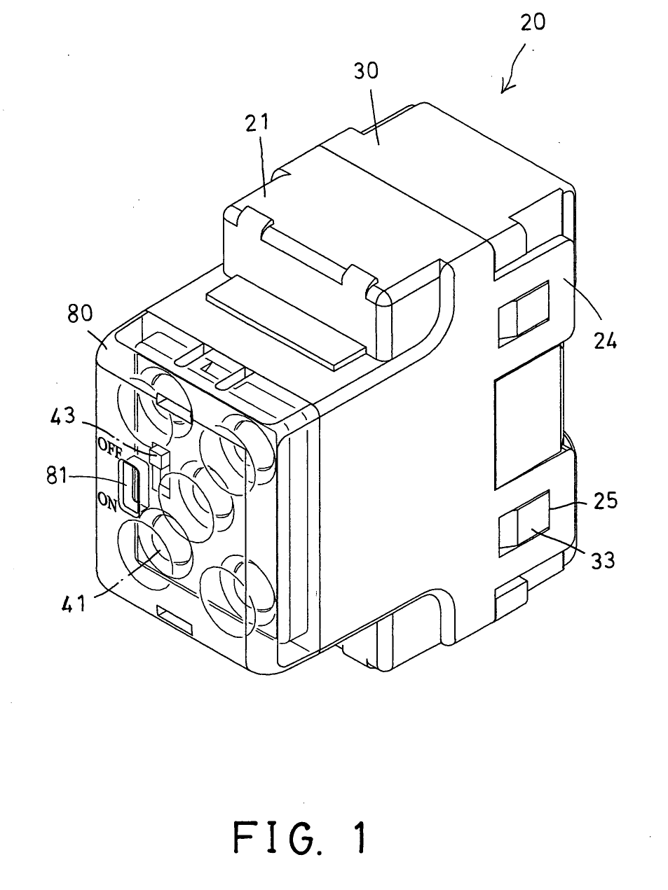

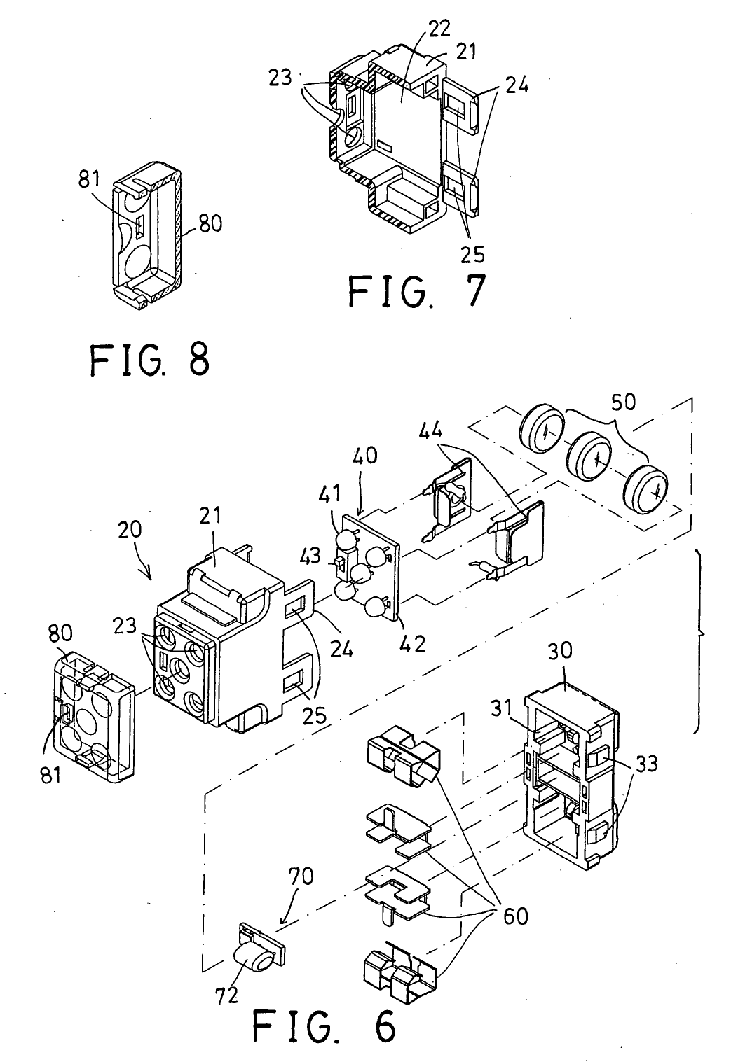

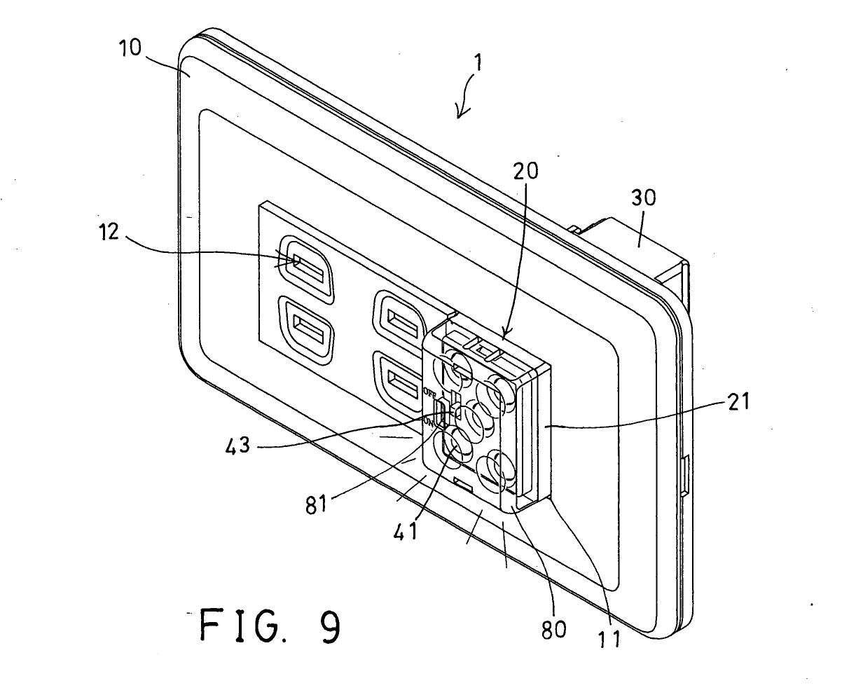

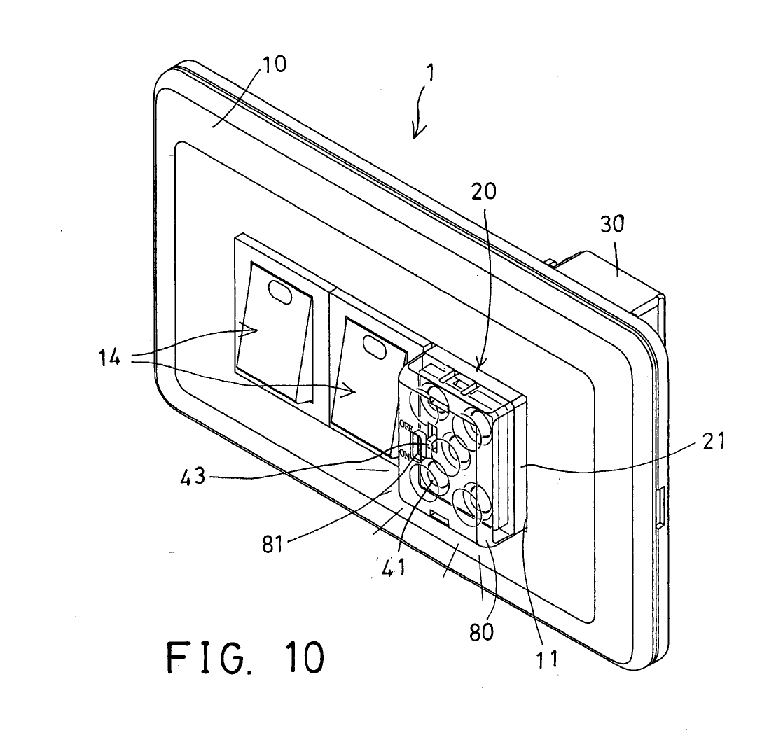

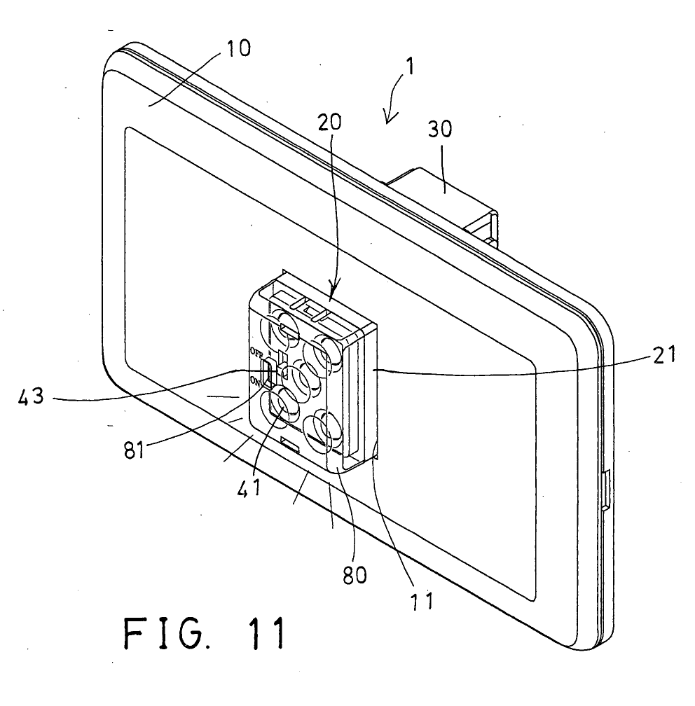

Referring to the drawings, and initially to FIGS. 9-11, a wall outlet device 1 in accordance with the present invention comprises a wall plate 10 for attaching or securing onto various wall members of house buildings, and including one or more orifices 11 formed therein for receiving an emergency light device 20 therein (FIGS. 1-6), and including one or more socket openings 12 formed therein (FIG. 9) for receiving or plugging various kinds of plugs (not shown) or the like, and/or including one or more switches 14 provided therein (FIG. 10) for controlling various kinds of electric facilities (not shown).

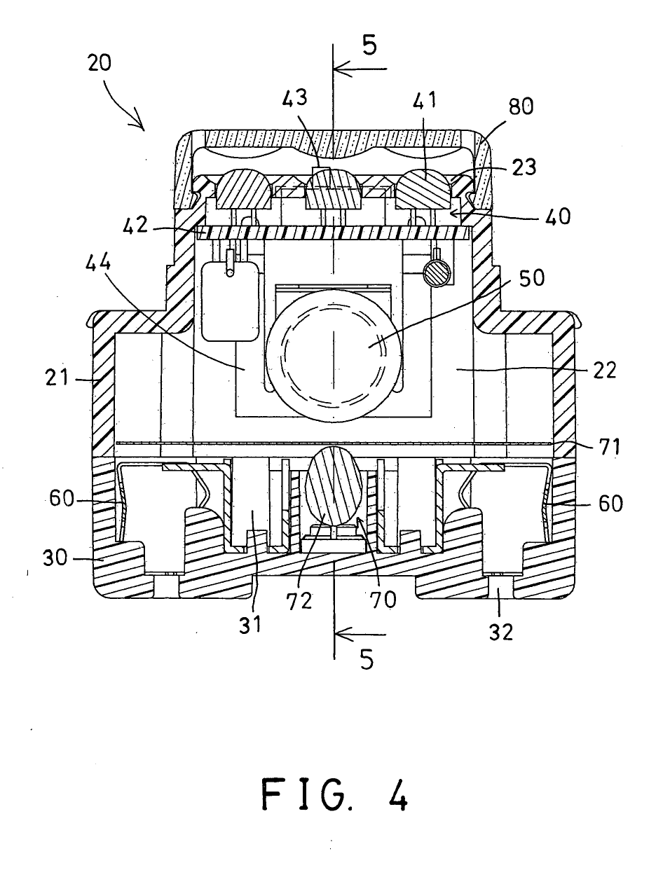

As shown in FIGS. 1-7, the emergency light device 20 includes an outer housing 21 for engaging into the orifices 11 of the wall plate 10 (FIGS. 9-11), and having a chamber 22 formed therein, for receiving a light device 40, one or more batteries 50, one or more pairs of conductor blades 60, and/or a control device 70 therein. The housing 21 includes one or more apertures 23 formed in the front portion thereof (FIGS. 4-7), and includes one or more ears 24 extended rearward from the rear portion thereof (FIGS. 1-2 and 6-7) and each having a lock hole 25 formed therein, for coupling or securing a rear casing 30 thereto.

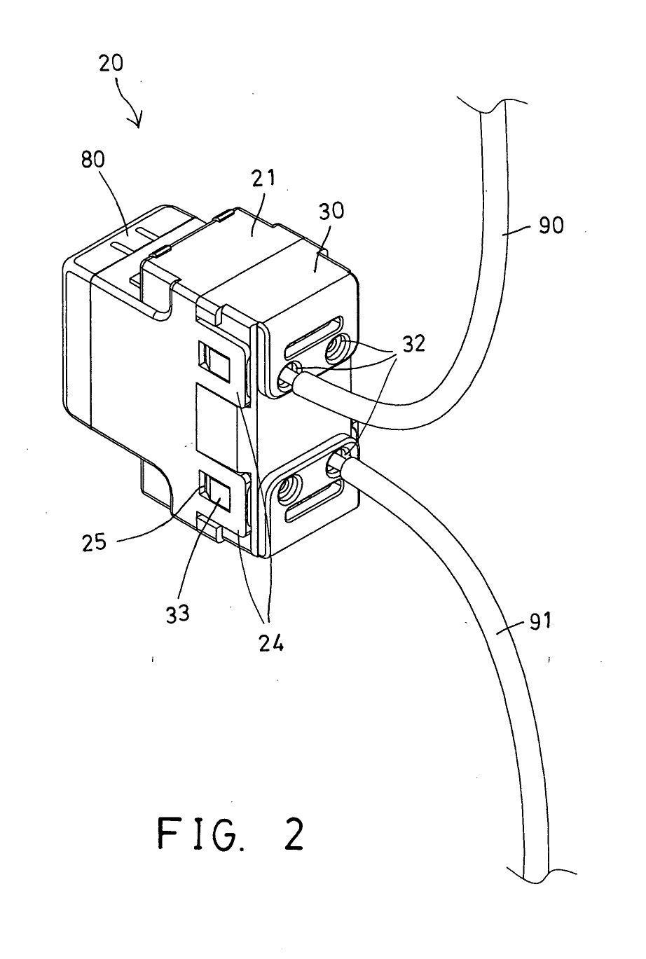

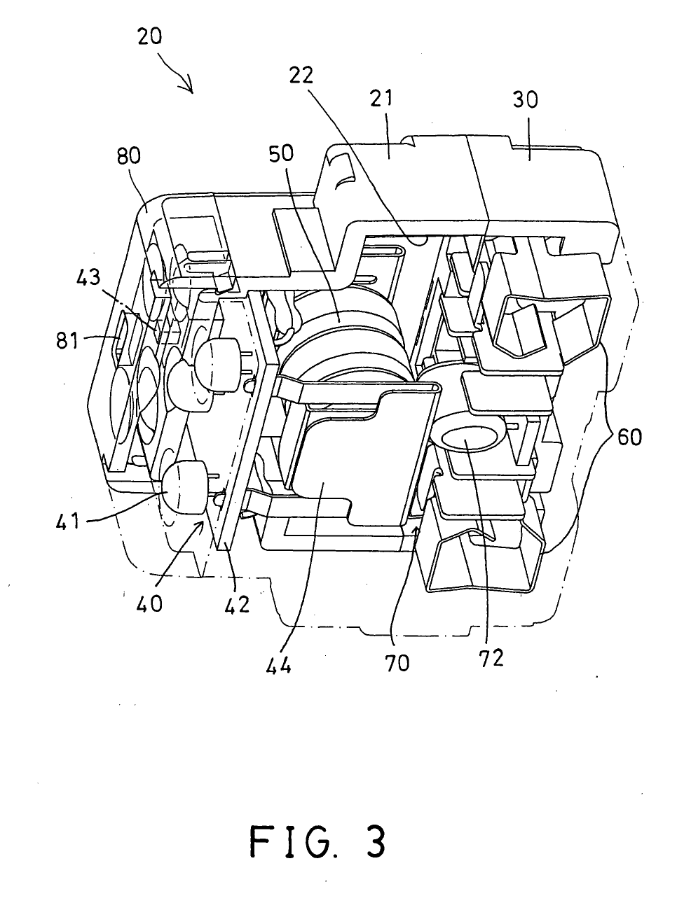

For example, the casing 30 also includes a chamber 31 formed therein (FIGS. 4-6), for receiving such as the batteries 50, the conductor blades 60, and/or the control device 70 therein (FIGS. 3, 4), and includes one or more passages 32 formed in the rear portion thereof (FIGS. 2, 4), and includes one or more lock projections 33 extended therefrom for engaging with the lock hole 25 of the ears 24 of the housing 21, and for detachably anchoring or coupling or securing the casing 30 to the housing 21, and thus for stably confining and retaining the light device 40, the batteries 50, the conductor blades 60, and/or the control device 70 within the housing 21 (FIGS. 3-5).

As best shown in FIG. 4, the conductor blades 60 are received or engaged within the chamber 31 of the casing 30, and aligned with the passages 32 of the casing 30 respectively, for allowing electric wires or cables 90, 91 (FIG. 2) to be engaged into the chamber 31 of the casing 30 via the passages 32 of the casing 30 respectively, and to be electrically coupled to the conductor blades 60 and/or the light device 40 and/or the control device 70, and thus for supplying electric energy to the wall outlet device 1.

The light device 40 includes one or more light members 41, such as light emitting diodes, illumination members, liquid crystal displays, etc., attached to a circuit or electric board 42, and engaged into or through the apertures 23 of the housing 21, for generating and emitting light out of the housing 21, and includes a switch 43 attached to such as the circuit or electric board 42, for controlling the light members 41. A cover 80, such as a transparent or semi-transparent cover 80 is attached to the front portion of the housing 21, for shielding and protecting the light members 41. The switch 43 is extended out through one of the apertures 23 of the housing 21, and the cover 80 includes a pathway 81 formed therein (FIG. 8) and aligned with the switch 43, for allowing the switch 43 to be actuated or operated by the users.

The light device 40 further includes a pair of conductor members 44 attached to the circuit or electric board 42 (FIGS. 3-6), and engaged with the batteries 50, for attaching or coupling the batteries 50 to the circuit or electric board 42 (FIGS. 3-6). The batteries 50 are preferably re-chargeable or chargeable by the electric energy supplied by the electric wires or cables 90, 91, for providing the electric energy to the light members 41 of the light device 40 and/or for energizing the light members 41 of the light device 40.

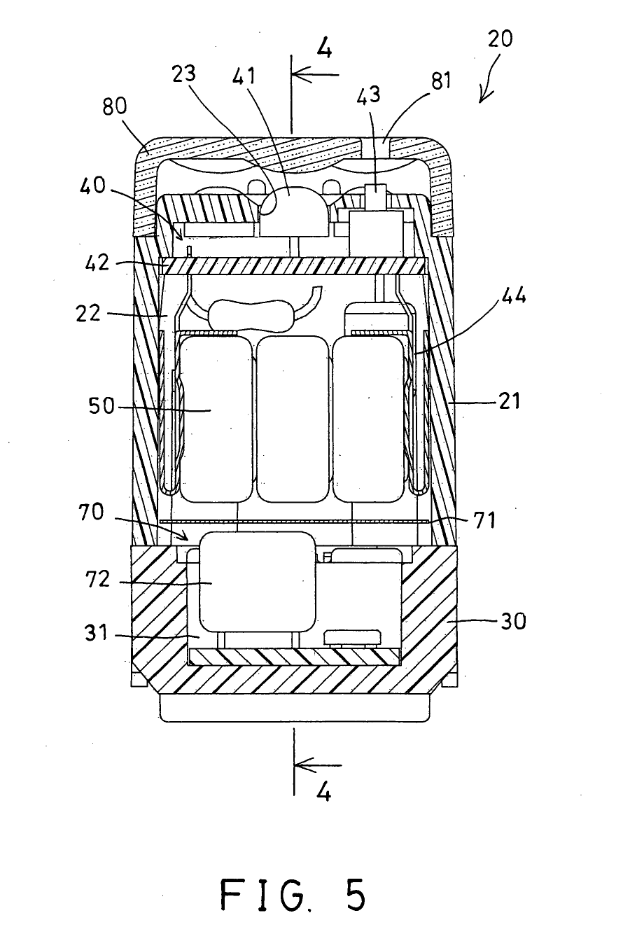

The control device 70 is electrically coupled to the conductor blades 60 and thus to the electric wires or cables 90, 91, and/or electrically coupled to the batteries 50 and/or the circuit or electric board 42 of the light device 40 with electric wires or cables 71 (FIGS. 4, 5), for being energized either by the electric energy supplied by the electric wires or cables 90, 91, or by the electric energy of the batteries 50. The control device 70 includes a sensing/switching circuit or device 72 electrically coupled to the conductor blades 60 and then to the electric wires or cables 90, 91, for sensing or detecting whether the power supply or the electric energy supplied from the electric wires or cables 90, 91 is cut off or not.

For example, the light members 41 of the light device 40 will not be operated or energized when the power supply or the electric energy is supplied to the electric wires or cables 90, 91; but will be operated or energized when the power supply or the electric energy supplied to the electric wires or cables 90, 91 is cut off or is not being supplied to the sensing/switching device 72 of the control device 70, particularly during a fire, the sensing/switching device 72 may switch and couple the batteries 50 to the circuit or electric board 42 and the light members 41 of the light device 40, for energizing the light members 41 of the light device 40, and thus for forming or acting as an emergency light device.

In operation, as shown in FIGS. 9-11, the wall outlet device 1 may include one or more emergency light devices 20 attached to the wall plate 10 which may be attached or secured onto various wall members of house buildings, for acting as an emergency light device, and for generating indicating light to light the dark environment, when such as the electric power source is cut off, particularly when on fire. The emergency light devices 20 may also be directly attached or secured onto various wall members of house buildings without the wall plate 10, and include a greatly reduced volume and may thus be easily attached to the wall plates 10 that are attached or secured onto various wall members of house buildings, and thus benefit people much.

Accordingly, the wall outlet device having emergency light in accordance with the present invention includes an emergency light for generating indicating light when the electric power source is cut off, particularly for the dark environment.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wall outlet device comprising:
a housing including a chamber formed therein,
a light device received in said chamber of said housing, and including at least one light member for generating a light out of said housing,
at least one chargeable battery coupled to said at least one light member of said light device, for selectively energizing said light device, and
a control device including a sensing/switching device for electrically coupling to a power supply, and electrically coupled to said at least one light member of said light device, for detecting whether the power supply is supplied to said sensing/switching device of said control device or not, and for controlling said at least one chargeable battery to energize said at least one light member of said light device when the power supply is not supplied to said sensing/switching device of said control device.

2. The wall outlet device having emergency light as claimed in claim 1, wherein said housing includes at least one aperture formed in a front portion thereof, and said at least one light member of said light device is engaged in said at least one aperture of said housing.

3. The wall outlet device having emergency light as claimed in claim 1, wherein said housing includes a cover attached to a front portion thereof for shielding and protecting said at least one light member of said light device.

4. The wall outlet device having emergency light as claimed in claim 2, wherein said light device includes a switch attached to a circuit board for controlling said at least one light member, and said cover includes a pathway formed therein and aligned with said switch, for allowing said switch to be actuated and operated by a user.

5. The wall outlet device having emergency light as claimed in claim 4, wherein said light device includes a pair of conductor members attached to said circuit board and engaged with said at least one chargeable battery, for attaching said at least one chargeable battery to said electric board.

6. The wall outlet device having emergency light as claimed in claim 1, wherein said housing includes a casing attached to a rear portion thereof and having a chamber formed therein for receiving said control device therein.

7. The wall outlet device having emergency light as claimed in claim 6, wherein said casing includes at least one passage formed therein, and at least one pair of conductor blades engaged in said chamber of said casing and aligned with said at least one passage of said casing, for allowing electric wires to engage into said chamber of said casing and to be electrically coupled to said at least one pair of conductor blades.

8. The wall outlet device having emergency light as claimed in claim 6, wherein said casing includes at least one projection extended therefrom, and said housing includes at least one ear extended therefrom and having a lock hole formed therein for receiving said at least one projection of said casing, and for coupling said casing to said housing.
